(19) United States
(12) Patent Application Publication
(10) Pub. No.: US 2025/0054646 A1
(43) Pub. Date: Feb. 13, 2025

(54) Method and System for Using Quantum Incompressible Fluid to Achieve Fusion from Cavitation

(71) Applicant: The Regents of the University of California, Oakland, CA (US)

(72) Inventors: Seth Putterman, Malibu, CA (US); John Koulakis, Oakland, CA (US); Seth L. Pree, Oakland, CA (US); Daniels Krimans, Oakland, CA (US)

(21) Appl. No.: 18/720,088

(22) PCT Filed: Dec. 19, 2022
(86) PCT No.: PCT/US2022/081960

§ 371 Date: Jun. 14, 2024

Related U.S. Application Data
(60) Provisional application No. 63/291,061, filed on Dec. 17, 2021.

(51) Int. Cl. G21B 1/11; H05H 3/06

(52) U.S. Cl. CPC G21B 1/11; H05H 3/06

(57) ABSTRACT

Disclosed herein is a system for generating neutrons with thermal fusion, composition for use in the same, and method of using the same. The system comprises a crucible, the crucible having a quantum incompressible fluid and a gas bubble therein, a piston having an end submerged within the quantum incompressible fluid, and a controller coupled to the piston configured to drive the piston to generate an acoustic resonance in the quantum incompressible fluid.

### CROSS-REFERENCE TO RELATED APPLICATIONS

This application is related to, claims priority to, and incorporates herein by reference for all purposes U.S. Provisional Patent Application No. 63/291,061, filed on Dec. 17, 2021.

### STATEMENT REGARDING FEDERALLY SPONSORED RESEARCH

This invention was made with government support under Grant Number HQ0034-20-1-0034, awarded by U.S. Department of Defense, Defense Advanced Research Projects Agency. The government has certain rights in the invention.

### BACKGROUND OF THE INVENTION

Despite the enormous interest in reaching controlled thermonuclear fusion as a source of limitless energy, there exists no laboratory scale thermal fusion device. Even for efficiencies Q<<1 a single laboratory scale thermal fusion instrument would be transformational. Such a device would become an experimental test bed for a spectrum of innovative ideas aimed at improving Q and understanding this process under wide ranging conditions.

### BRIEF SUMMARY OF THE INVENTION

Disclosed herein is a system for generating neutrons with thermal fusion, composition for use in the same, and method of using the same. The system comprises a crucible, the crucible having a quantum incompressible fluid and a gas bubble therein, a piston having an end submerged within the quantum incompressible fluid, and a controller coupled to the piston configured to drive the piston to generate an acoustic resonance or an impulse in the quantum incompressible fluid.

Another aspect of the invention provides for compositions comprising a quantum incompressible fluid and a gas bubble therein. In some embodiments, the quantum incompressible fluid is a molten salt or liquid metal. In some embodiments, the quantum incompressible fluid has a strength of singularity n≤0.5, a yield stress B≥5000 atm, an adiabatic compressibility coefficient is Γ≥9, or any combination thereof. In some embodiments, the gas bubble comprises deuterium and/or tritium and a hammer gas.

Another aspect of the invention provides for a method for thermonuclear generation of neutrons, the method comprising cavitating a gas bubble within a quantum incompressible fluid, wherein the gas bubble comprises deuterium or tritium and a hammer gas. Suitably, the temperature within the cavitating gas bubble reaches a maximum ≥1.0 MK. The method may be performed in the system described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates the strength of the singularity, n, which characterizes a collapsing cavity surrounded by a fluid with a compressibility coefficient Γ. The dashed line is the incompressible limit which is Γ=∞. The cross is positioned at the value for water.

FIG. 2 Scaled radius as a function of time for a single bubble implosion showing the transition from incompressible motion, n=0.4 (dashed line A) to compressible motion n=0.558 for water (dashed line B).

FIG. 3 Radius, R_{c} at which the fluid motion shows a transition from incompressible to compressible flow as a function of the equation of state parameterized by Γ.

FIG. 4 (lower panel) shows the radius of a collapsing argon bubble in an incompressible fluid. The lines (C-E) are characteristics launched from the interface between gas and fluid towards the center of the bubble. Where the characteristics cross a shock forms. The upper panel shows a molecular dynamics simulation of the gas inside of the imploding bubble wall. The shock front at small ‘r’ is the realization of the crossing characteristics as indicated by the solid arrow:

FIG. 5 illustrates simulated maximum temperature reached in a collapsing bubble containing deuterium and xenon surrounded by a quantum incompressible fluid. The percentages refer to the hydrogenic concentration. Here, 0 ps represents time at which minimum radius occurs as predicted by Rayleigh's equation. Also, notice that even though bubble collapse happens on the scale of microseconds, temperature peaks occur on the scales of picoseconds.

FIG. 6 illustrates characteristics launched by the wall of a collapsing bubble in water do not cross and so an imploding shock wave does not form.

FIG. 7 illustrates the radius as a function of time for a collapsing bubble in a fluid with n=0.5. The curves are characteristics launched into the bubble's interior. The gas inside the bubble is here modelled as an adiabatically compressed ‘fluid’.

FIG. 8 illustrates a system for generating cavitation in a quantum incompressible fluid.

### DETAILED DESCRIPTION OF THE INVENTION

Disclosed herein is a thermal fusion system and methods of using the same. The thermal fusion system utilizes a quantum incompressible fluid to focus energy in a cavitating gas bubble within the quantum incompressible fluid. As a result, the temperature within the cavitating gas bubble may reach maximum temperatures more than a MK. Such a system will allow for the generation of neutrons and may be implemented on a bench-top scale.

In target fusion, all of the energy of a missed collision is lost to heat. In thermal fusion, a large fraction of the energy of missed collision maintains the plasma. The presently disclosed device utilizes sonoluminescence (SL). SL is a phenomenon where passage of a sound wave through a fluid creates picosecond flashes of ultraviolet light. This is achieved via the pulsation of a bubble of gas inside a fluid. The bubble extracts energy from the sound field by expanding during the rarefaction phase and then concentrates that energy to its interior during a subsequent implosion that reaches supersonic velocities. The vibrational energy of molecules in the sound wave is about 10-11 eV yet the emitted photons have an energy of about 6 eV of magnitude. As a result, SL spontaneously concentrates the energy density of a sound wave by about 12 orders of magnitude. SL can also be achieved via an impulsive pressure pulse which crushes the bubble. The present technology can also be used to crush bubbles in a quantum incompressible fluid for thermonuclear generation of neutrons.

The present technology utilizes a quantum incompressible fluid to achieve MK maximum temperatures within a cavitating gas bubble. A quantum incompressible fluid is a fluid that exhibits strong pairwise repulsion between neighboring particles or atoms with small displacements toward each other from equilibrium. Such repulsive energies arise from quantum repulsion, such as repulsion of overlapping electron shells, Fermi repulsion, exchange forces, and the like. An idealized quantum incompressible may be represented as a hard sphere fluid.

The compressible fluid will be characterized by the parameters n, B, and Γ. The quantum incompressible fluid should be chosen to have as low a compressibility as practical and as a high yield stress as practical. To achieve thermonuclear fusion from cavitation a fluid is needed where n≤0.5 and B≥5.000 atm.

For an incompressible fluid, the radius of a cavity approaches zero as R˜(t−t₀)ⁿ with n=4/10. A bubble surrounded by a fluid with n=4/10 will collapse to temperatures over 10 MK and achieve fusion. However, water and the other fluids that have been used for SL are hydrogen bonded and are therefore not incompressible. For example, water has an n of 0.555. As a result the pressure which builds up in the fluid due to the dynamics of the collapse does work on the fluid and subtracts energy from the singularity and more importantly slows down the collapse.

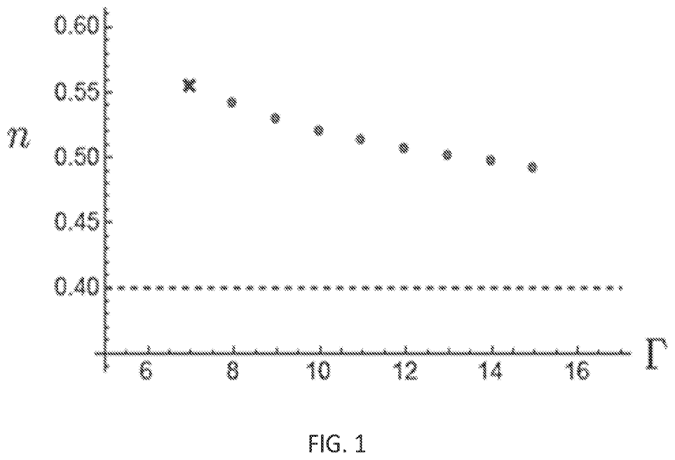

Fluids under pressure can be characterized by a Tait-Murnaghan equation of state p=B[(ρ/ρ₀)^{Γ}−1] where Γ is the adiabatic compressibility coefficient and B is the yield stress. FIG. 1 shows the strength of the singularity, n, as a function of the compressibility coefficient. Small changes in n have an enormous effect on the degree of energy concentration that can be achieved. For water Γ=7 and n=0.555 which will be compared to an incompressible fluid where Γ=∞, n=0.40. In the incompressible limit, temperatures appropriate to fusion are achieved, but that for water the temperatures achieved are much lower and the implosion is dramatically weaker.

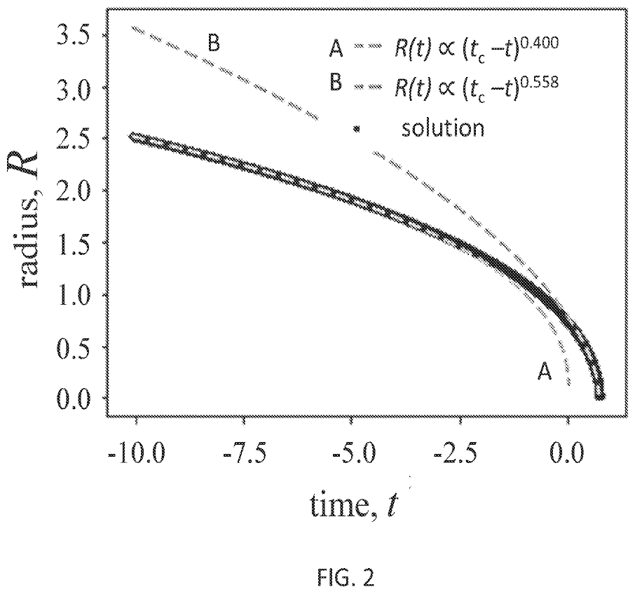

A theoretical study for understanding the nature of the bubble collapse in a real or compressible fluid compared to an ideal or incompressible fluid is shown in FIG. 2. FIG. 2 shows the radius vs time of a cavity in a fluid with Γ=7. Note that at early times when the motion is subsonic, the fluid is incompressible and follows n=2/5, but as the cavity reaches a small R the motion asymptotes to n=5/9. This is the transition to compressible flow which suppresses the second step in energy focusing. Slowing down of the acceleration of the bubble wall due to compressibility suppresses launching of the imploding shock wave.

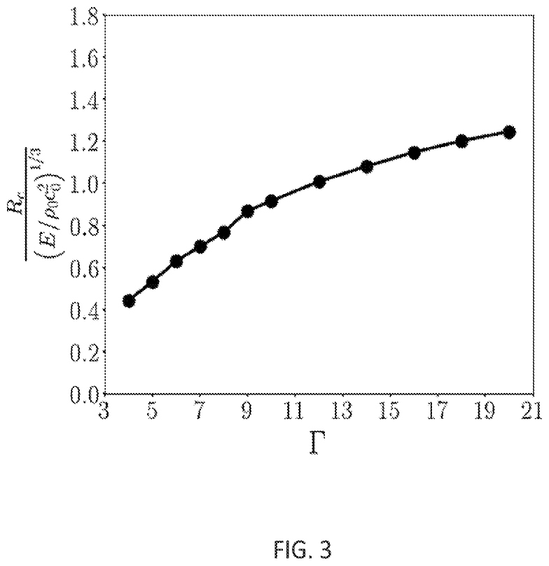

The transition radius R_{c} has been evaluated down to a point where the motion can be regarded as incompressible, and below which the motion becomes compressible. For the case Γ=7 the transition to compressible flow occurs at a physically relevant radius. The dashed line A represents the behavior of a bubble in an ideal fluid and the dashed line B represents the behavior of a bubble in a typical real fluid such as water in this case. The transition from ideal behavior (i.e., ideal for fusion, such as in a quantum incompressible fluid) to nonideal behavior (i.e., not ideal for fusion, such as in a compressible fluid) is labelled R_{c}, and has been calculated for a general equation of state as shown in FIG. 3. The quantum fluid's equation of state may be chosen so that R_{c} is small enough to launch an imploding shock wave.

In some embodiments, the quantum incompressible fluid has a strength of singularity n≤0.50. In some embodiments, the strength of singularity is between 0.50 and 0.40, 0.49 and 0.40, 0.48 and 0.40, 0.47 and 0.40, 0.46 and 0.40, 0.44 and 0.40, 0.43 and 0.40, 0.42 and 0.40, or 0.41 and 0.40.

In some embodiments, the quantum incompressible fluid has a yield stress B of ≥5000 atm. In some embodiments, B is between 5,000 atm and 50,000 atm.

In some embodiments, the quantum incompressible fluid has an adiabatic compressibility Γ≥9. In some embodiments, the quantum incompressible fluid has an adiabatic compressibility greater than 10, 11, 12, 13, 14, 15, or more.

In some embodiments, the quantum incompressible fluid is a molten salt or liquid metal. Exemplary molten salts include those characterized has having hard cations and anions. Hard ions are generally characterized as behaving more like hard sphere. Hard cations may be characterized as having no outer-shell electrons, e.g., Li⁺, Na⁺, K⁺, Be²⁻, Mg²⁺, Ca²⁺, Al³⁺, and others having a noble-gas like outer shell) are conventionally considered hard cations. Hard cations may also be characterized by having a small ionic radius (e.g., <90 pm), positive charge, low electronegativity (e.g., 0.7-1.6) or low electron affinity, high energy LUMO, and d orbital unavailable for bonding. Hard anions may be characters by having a small ionic radius (e.g., <150 pm), electronegative atomic centers (e.g., 3.0-4.0), weak polarizability, are difficult to oxidize, and a high energy HOMO. Exemplary hard anions include, without limitation, F⁻, Cl⁻, O²⁻, OH⁻, Exemplary molten salts include molten alkali halides, such as LiF.

In some embodiments, the liquid metal is selected from liquid lithium, sodium, magnesium, aluminum, or zinc but other metals may also be used.

In some embodiments, the quantum incompressible fluid has a low vapor pressure. Low vapor pressure refers to a quantum incompressible fluid≤1 torr.

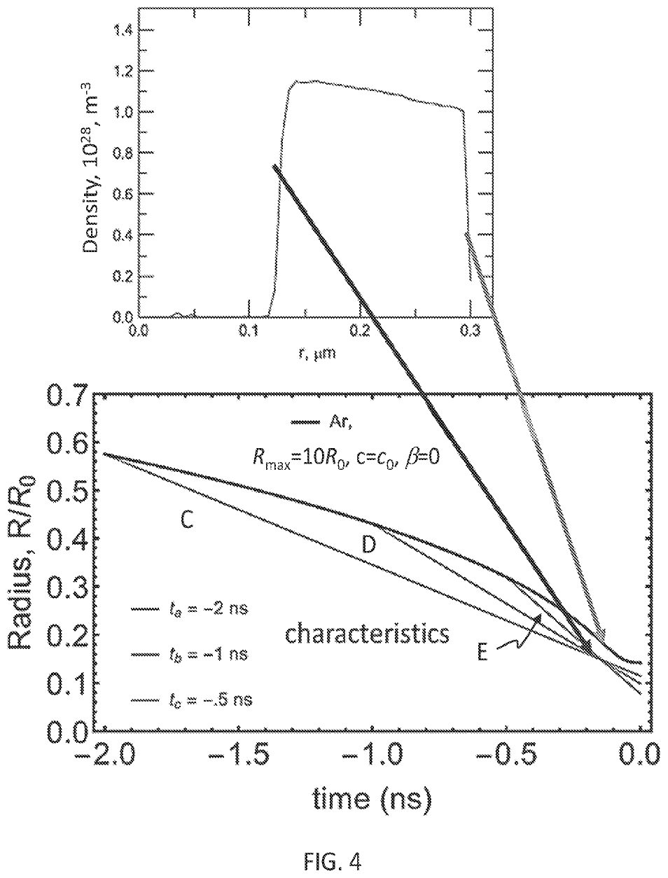

The use of a quantum incompressible fluid is illustrated in FIG. 4. FIG. 4 shows the radius of a bubble in an incompressible fluid as a function of time [black curve] near the moment of collapse. At each moment in time the wall can be thought of as launching a characteristic [lines] into the gas in the bubble's interior which in this case in argon. A characteristic propagates with the local space and time at the speed of sound. For an incompressible fluid, the characteristics cross prior to realization of the minimum radius: the consequence being that a spherical imploding shock wave is launched into the bubble's interior. FIG. 4 shows three example characteristics launched at −2 ns, −1 ns, and −0.5 ns that cross at about −0.12 ns. The shock wave provides a second level of energy density concentration as implied by the singular Guderley solution as contained in the hydrodynamic calculations of Wu and Roberts [C. C. Wu and P. H. Roberts, “Shock-wave Propagation in a Sonoluminescing Gas Bubble,” Phys. Rev. Lett. 70, 3424 (1993)]. Without wishing to be bound by theory, one can observe an imploding shock wave forms well inside the bubble if one takes the R (t) curve from the lower panel of FIG. 4 and uses that as the boundary condition for a molecular dynamics simulation of the gas inside the bubble. The solid arrow connects the spherical shock front to the crossing characteristics. The dashed arrow connects the location of the bubble wall in the upper and lower panels of the figure.

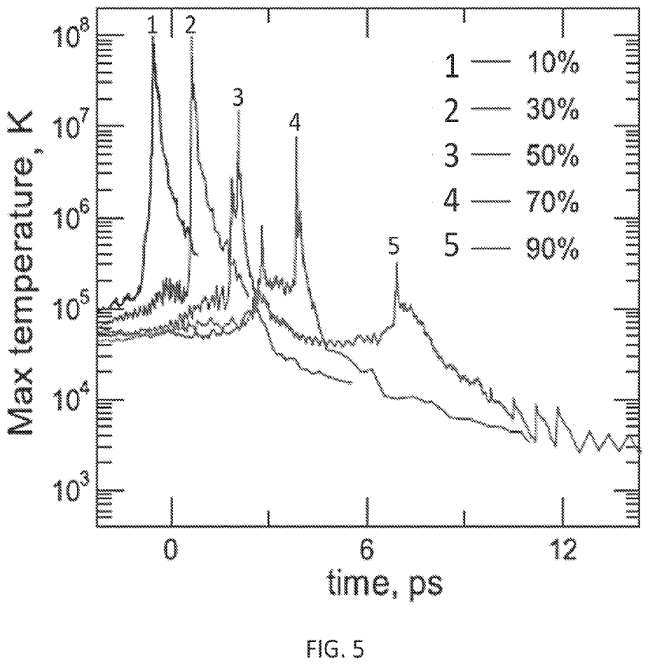

Under the conditions displayed in FIG. 4 a molecular dynamics simulation yields the temperature reached at the center of the bubble as the shock wave focuses to the origin. As seen in FIG. 5 this temperature can reach 100 MK (108 K). In this case the simulated bubble contains a mixture of spheres with the properties of xenon and deuterium. As the speed of sound is higher for lower molecular weight deuterium, the deuterium actually accumulates at the center where the temperature is highest.

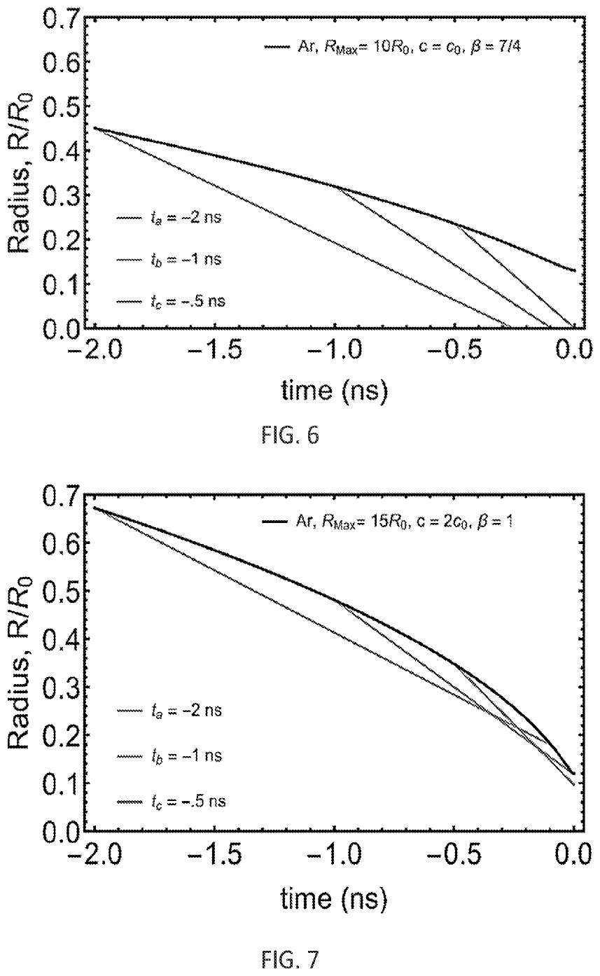

The imploding shock wave plays a special role in achieving these high temperatures. Once the shock front forms it can focus to the origin even in the presence of the gas. It is a singularity that cannot be thwarted. This can be compared to the bubble wall which cannot get smaller than the hard sphere radius of the molecules it encloses. The role of compressibility in suppressing shock formation is shown in FIG. 6. Here is the hydrodynamic solution for the radius of a bubble surrounded by water so that n=5/9. The characteristics in this case do not cross and a shock wave is not formed. This results in temperatures much lower than when a quantum incompressible fluid is employed.

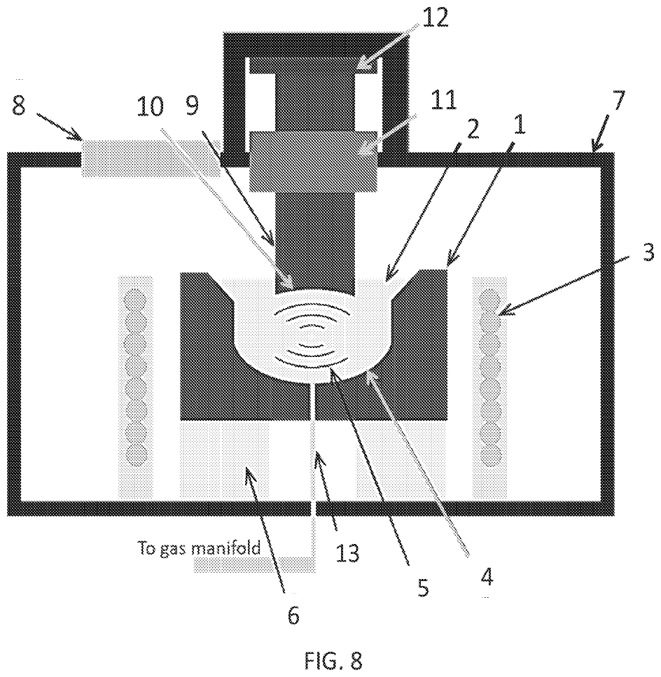

FIG. 7 provides estimates of characteristics crossing in a putative fluid with Γ=15 so that the critical exponent for the bubble collapse is n=0.5.

To achieve thermonuclear fusion, the quantum incompressible fluid will operate under extreme conditions and high-amplitude sound waves are needed cause cavities to form expand and collapse with great force. The system described herein may operate at between 1,000K and 2000K, potentially include corrosive materials like lithium and fluorine, and require high amplitude sound field of ≥2 atm.

FIG. 8 illustrates an exemplary thermal fusion system operated by cavitation in quantum incompressible fluid. The system may operate impulsively or resonantly. The system comprises a crucible 1 having a quantum incompressible fluid 2 therein. The crucible is selected to withstand temperatures higher than the melting point of the quantum incompressible fluids. In some embodiments, the crucible may be made of graphite, sapphire, ceramic, high-temperature glass or other materials that remain solid at temperatures in excess of 1000, 1200, 1400, 1600, 1800, or 2000 K. The crucible material may also be selected to have minimal reactivity with the quantum incompressible fluid.

The crucible 1 is heated by a heater 3 to temperatures higher than the melting point of the quantum incompressible fluid. Possible heating methods include but are not limited to electric current carrying resistive wire, induction coils around resistive vessels, and radiative heating.

The shape of the crucible 1 is chosen to facilitate and enhance acoustic resonances in the quantum incompressible fluid so that high acoustic amplitude may be achieved. For example, an interior crucible boundary may be circular or parabolic in shape 4 so as to focus acoustic waves 5 impinging upon it. The shape of the crucible may also be chosen to facilitate viewing of the interior.

The crucible 1 is held by and placed in a thermally insulating environment. The insulating environment may comprise insulating blocks 6 or material upon which the crucible sits, such as insulating wraps around the crucible, and/or an evacuated vacuum chamber 7 to remove gaseous convective currents around the crucible that transport heat away from the crucible.

Visual access to the interior of the vessel may be maintained for diagnostic purposes. Windows 8 may be added to the vacuum chamber 7 surrounding the crucible for this purpose.

Gas is sparged into the molten salt through a tube 13 from a gas manifold passing through the crucible and optionally the vacuum chamber. The gas is chosen to enhance and enable cavitation and/or fusion activity and may consist of mixtures of gases. Exemplary gasses include, without limitation, hydrogen, deuterium, tritium, a noble gas (such as helium, argon, or xenon).

The gas within the quantum incompressible fluid may comprise a hammer gas and a hydrogenic gas, such as hydrogen, deuterium, tritium, or a combination thereof. A hammer gas should be selected as to have larger mass then the hydrogenic gas. The mass ratio of hammer gas to the hydrogenic gas may be greater than 5, 10, 15, 20, 25, or 30. The hammer gas may be selected from noble gas, such as argon or xenon. An exemplary gas mixture is deuterium and xenon.

In some embodiments, the concentration of hydrogenic gas to hammer gas is 50 mol % or less. In some embodiments, the hydrogenic concentration is 5-30 mol % or 10-20 mol %. As demonstrated in FIG. 5, as the concentration of hydrogenic gas decreases the maximum temperature attainable tends to increase.

The gas should be present in an amount that allows for bubble formation and cavitation. The amount of gas within the quantum incompressible fluid may be determined by the % of saturation of the gas within the quantum incompressible fluid. In some embodiments, the % of saturation is ≤5%. Suitably the % of saturation may be between about 1-5%.

A high-amplitude acoustic resonance is driven in the quantum incompressible fluid. The resonance may be, but is not required to be, driven by a piston 9 made of high-temperature, chemically-compatible material is held partially in the quantum incompressible fluid. The submerged end of the piston may have a shape 10 selected to generate or enhance a resonant mode. The piston may pass through the vacuum chamber wall via a mechanical feedthrough 11. The opposite end of the rod may be connected to a device 12, such as a piezoelectric device, capable of vibrating the piston and/or generate and send sound waves down the piston. The piston may be coupled to a controller for controlling the piston. The sound exits the piston into the quantum incompressible fluid and forms a standing wave in the shape of the resonant mode in the quantum incompressible fluid. Alternative methods for driving an acoustic wave in the molten salt include laser breakdown in the molten salt or periodic heating by electric or microwave pulses.

The piston may generate a high-amplitude sound field. As used herein a high-amplitude sound field is a sound field of ≥2 atm. Suitably, the high-amplitude sound field may be between 2-5 atm.

Additionally, and alternatively, the piston can be used as an impulsive system to launch a high-amplitude pressure pulse into a fluid in the crucible. The pressure pulse or shockwave encounters a bubble in the crucible and causes the bubble to implode so as to focus the energy and cause fusion to occur. The shockwave can be shaped in time. For example, the shockwave can include a transition between a first pressure and a second pressure over a distance, where the second pressure is higher than the first pressure. In general the distance must be greater than the radius of the bubble that is to be imploded. This distance will typically be from 1 mm to 2 cm. The distance characterizes the thickness of the shockwave. The first pressure can be less than a tenth of an atmosphere and the second pressure can be greater than 10 atmospheres.

The shape of the pressure pulse is characterized by the transition, or the change in pressure between the first pressure and the second pressure. The transition can be a linear or nonlinear change in pressure over the distance. The thickness of the shockwave transition can be on the order of the radius of the bubble. For example, the shockwave thickness of the impulsive system can be 50%-100% larger than the bubble to maximize sphericity. The distance of the transition, or shockwave thickness, is relevant to the mechanism of bubble implosion. For example, if the thickness is too small, then the bubble is squeezed irregularly when the shockwave encounters it, and shatters the bubble such that no characteristics cross, the energy is not focused, and fusion will not occur. The pressure pulse may be shaped in time to maximize sphericity of the bubble cavitation. This occurs when the thickness of the shockwave is comparable or larger than the initial radius of the bubble.

The shape of the pressure pulse can be influenced by or determined by the shape of the piston shape 10 or by the shape of the crucible 5. In one example, the shape 10 can be planar, generating a planar shockwave. The piston is a non-limiting example of a device that may be used to deliver the high amplitude pressure pulse.

Advantageously, the device described herein may be implemented on a bench-top scale. As used herein, bench-top scale refers to a device having dimensions or sized to fit onto a laboratory bench or tabletop.

Operation of the device allows for achieving maximum temperatures within the cavitating gas bubble of greater than 1.0 MK. In some embodiments with the selection of an appropriate quantum incompressible fluid and gas, the device is capable of achieved maximum temperatures more than 10.0, 50.0, or 100.0 MK. When such high temperatures are achieved, gases comprising deuterium and/or tritium within the quantum incompressible fluid allows for the thermal fusion and the generation of neutrons.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A system comprising a crucible, the crucible having a quantum incompressible fluid and a gas bubble therein, a piston having an end submerged within the quantum incompressible fluid, a heater thermally coupled to the crucible, and a controller coupled to the piston configured to drive the piston to generate an acoustic resonance in the quantum incompressible fluid.

2. The system of claim 1, wherein the quantum incompressible fluid is a molten salt or liquid metal.

3. The system of any one of claims 1-2, wherein the quantum incompressible fluid has a strength of singularity n≤0.5.

4. The system of any one of claims 1-3, wherein the quantum incompressible fluid has a yield stress B≥5000 atm.

5. The system of any one of claims 1-4, wherein the quantum incompressible fluid has an adiabatic compressibility coefficient is Γ≥9.

6. The system of any one of claims 1-5, wherein the gas bubble comprises deuterium and/or tritium and a hammer gas.

7. The system of claim 6, wherein the gas bubble comprises 10-20 mol % deuterium.

8. The system of any one of claims 1-7, wherein the gas in the quantum incompressible fluid is present in an amount ≤5% of saturation.

9. The system of any one of claims 1-8, wherein the piston is configured to generate a high-amplitude sound field of ≥2 atm.

10. The system of any one of claims 1-9, wherein the heater is configured to heat the crucible to a temperature of ≥700 K

11. A composition comprising a quantum incompressible fluid and a gas bubble therein.

12. The composition of claim 11, wherein the wherein the quantum incompressible fluid is a molten salt or liquid metal.

13. The composition of any one of claims 11-12, wherein quantum incompressible fluid has a strength of singularity n≤0.5.

14. The composition of any one of claims 11-13, wherein the quantum incompressible fluid has a yield stress B≥5000 atm.

15. The composition of any one of claims 11-14, wherein the adiabatic compressibility coefficient is Γ≥9.

16. The composition of any one of claims 11-15, wherein the gas bubble comprises deuterium or tritium and a hammer gas.

17. The composition of claim 16, wherein the gas bubble comprises 10-20 mol % deuterium.

18. The composition of any one of claims 10-16, wherein the gas in the quantum incompressible fluid is present in an amount ≤5% of saturation.

19. A method for thermonuclear generation of neutrons, the method comprises providing a pressure pulse or cavitating a gas bubble within a quantum incompressible fluid, wherein the gas bubble comprises deuterium, tritium, or other nuclear fuel and a hammer gas.

20. The method of claim 19, wherein the temperature within the cavitating gas bubble reaches a maximum ≥1.0 MK.

21. The method of any one of claims 19-20, wherein the gas bubble is cavitated by a high-amplitude sound field.

22. The method of any one of claims 19-20, wherein the gas bubble is imploded by an impulse.

23. The method of claim 22, wherein the impulse is shaped in time to maximize sphericity of the imploding gas bubble.

24. The method of any one of claims 19-23, wherein the method is performed with the system according to any one of claims 1-10.

25. The method of claim 24, wherein the crucible is heated to a temperature of ≥700 K.

26. The method of any one of claims 24-25, wherein the piston is driven to generate a high-amplitude sound field of ≥2 atm.

27. The method of any one of claims 24-26, wherein the piston provides a shaped pressure pulse.

28. The method of any one of claims 19-27 further comprising modulating fusion output to gain energy by burning deuterium, tritium, or the other nuclear fuel.

29. The method of claim 28, wherein the fusion output is modulated by modulating the sound field, frequency, geometry, gas mixture, fluid composition, or any combination thereof.

30. The method of any one of claims 19-29 further comprising circulating the quantum incompressible fluid, thereby replenishing deuterium, tritium, or the other nuclear fuel and/or capturing produced energy.
